(19) United States
(12) Patent Application Publication
(10) Pub. No.: US 2015/0188308 A1
(43) Pub. Date: Jul. 2, 2015

(54) INVERTER APPARATUS

(71) Applicant: SAMSUNG ELECTRO-MECHANICS CO., LTD., Suwon-Si (KR)

(72) Inventor: Min Gyu PARK, Suwon-Si (KR)

(73) Assignee: SAMSUNG ELECTRO-MECHANICS CO., LTD., Suwon-Si (KR)

(21) Appl. No.: 14/266,296

(22) Filed: Apr. 30, 2014

(30) Foreign Application Priority Data
Dec. 30, 2013 (KR) 10-2013-0167691

(51) Int. Cl. H02H 7/08; H02H 7/122

(52) U.S. Cl. CPC H02H 7/08; H02H 7/122

(57) ABSTRACT

An inverter apparatus may include: a switching unit including a plurality of switches connected to a plurality of phases of a motor apparatus and performing a switching operation to provide a driving current to at least a portion of phases among the plurality of phases; an overcurrent detecting unit connected to the switching unit and determining whether or not the driving current flowing in the switching unit is in an overcurrent state; and a controlling unit turning at least a portion of the plurality of switches off in response to an output of the overcurrent detecting unit.

### CROSS-REFERENCE TO RELATED APPLICATION

This application claims the benefit of Korean Patent Application No. 10-2013-0167691 filed on Dec. 30, 2013, with the Korean Intellectual Property Office, the disclosure of which is incorporated herein by reference.

### BACKGROUND

The present disclosure relates to an inverter apparatus capable of protecting against overcurrent.

An inverter apparatus, a unit of applying a driving current to a motor apparatus, or the like, has been used in various fields.

Since such an inverter apparatus has a driving current applied thereto and provides the driving current to the motor apparatus, detection of an overcurrent for protecting a motor apparatus or an inverter apparatus when the overcurrent flows has become an important issue.

In the case of an inverter apparatus according to the related art, overcurrent detection and protection have been performed in a manner in which a predetermined sensing resistor is additionally disposed between an output terminal of the inverter apparatus and a plurality of phases of the motor apparatus and a switching operation of an inverter unit is controlled depending on a magnitude of a driving current detected by the sensing resistor.

However, according to the related art, since the detected overcurrent is a current which has already passed through the inverter unit, damage to the motor apparatus or the inverter apparatus may be caused by the detected overcurrent even though the overcurrent is detected. Particularly, since a switching element of the inverter apparatus is vulnerable to the overcurrent, the switching element may be already damaged even in a case in which the overcurrent is detected and blocked.

Patent Document 1, which relates to an overcurrent protection circuit for an inverter, and Patent Document 2, which relates to an inverter protection circuit for a railroad car, disclose contents related to current protection of an inverter, but still do not solve the above-mentioned defects.

### RELATED ART DOCUMENTS

(Patent Document 1) Korean Patent Laid-Open Publication No. 10-2001-0073796

(Patent Document 2) Korean Utility Model Laid-Open Publication No. 20-1998-0049572

### SUMMARY

An aspect of the present disclosure may provide an inverter apparatus in which damage to a switching element of an inverter may be protected, even in a case in which an overcurrent is detected and a protection operation is performed.

According to an aspect of the present disclosure, an inverter apparatus may include: a switching unit including a plurality of switches connected to a plurality of phases of a motor apparatus and performing a switching operation to provide a driving current to at least a portion of phases among the plurality of phases; an overcurrent detecting unit connected to the switching unit and determining whether or not the driving current flowing in the switching unit is in an overcurrent state; and a controlling unit turning at least a portion of the plurality of switches off in response to an output of the overcurrent detecting unit.

The switching unit may include a plurality of high side switches connected to positive terminals of the plurality of phases; and a plurality of low side switches connected to negative terminals of the plurality of phases.

The controlling unit may turn at least a portion of the plurality of low side switches off when the output of the overcurrent detecting unit is an overcurrent detection signal.

The overcurrent detecting unit may be connected to a first terminal and a second terminal of a high side switch included in the switching unit.

The overcurrent detecting unit may include: a divider dividing the driving current at a preset ratio; a first comparator comparing a voltage of the divided current output from the divider with a preset upper limit voltage value; and a second comparator comparing the voltage of the divided current with a preset lower limit voltage value.

The first comparator may detect whether or not the driving current is in the overcurrent state.

The second comparator may detect a short circuit occurring in at least one of the plurality of switches.

The controlling unit may turn the at least a portion of the plurality of switches off when an output of at least one of the first comparator or the second comparator is in a high state.

The overcurrent detecting unit may include: a first comparator comparing the driving current with a preset upper limit voltage value; and a second comparator comparing the driving current with a preset lower limit voltage value.

According to another aspect of the present disclosure, an inverter apparatus may include: a switching unit including a plurality of switches connected to a plurality of phases of a motor apparatus and performing a switching operation to provide a driving current to at least a portion of phases among the plurality of phases; an overcurrent detecting unit connected to an input terminal of the switching unit and determining whether or not the driving current flowing in the switching unit is in an overcurrent state; a current detecting unit connected to an output terminal of the switching unit and detecting the driving current flowing in the switching unit; and a controlling unit turning at least a portion of the plurality of switches off using outputs of the current detecting unit and the overcurrent detecting unit.

The switching unit may include a plurality of high side switches connected to positive terminals of the plurality of phases; and a plurality of low side switches connected to negative terminals of the plurality of phases.

The controlling unit may turn at least a portion of the plurality of low side switches off when the driving current is in the overcurrent state.

The overcurrent detecting unit may be connected to the plurality of high side switches and the current detecting unit may be connected to the plurality of low side switches.

The overcurrent detecting unit may include: a divider dividing the driving current at a preset ratio; a first comparator comparing a voltage of the divided current output from the divider with a preset upper limit voltage value; and a second comparator comparing the voltage of the divided current with a preset lower limit voltage value.

The first comparator may detect whether or not the driving current is in the overcurrent state.

The second comparator may detect a short circuit occurring in at least one of the plurality of switches.

The controlling unit may turn the at least a portion of the plurality of switches off when an output of at least one of the first comparator or the second comparator is in a high state.

The overcurrent detecting unit may include a first comparator comparing the driving current with the preset upper limit voltage value, and the first comparator may detect a short circuit in a high side switching element of the switching unit.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a circuit diagram showing an example of a general inverter apparatus;

FIG. 2 is a configuration diagram showing an example of an inverter apparatus according to an exemplary embodiment of the present disclosure;

FIG. 3 is a configuration diagram showing an example of an overcurrent detecting unit of FIG. 2;

FIG. 4 shows an example of a circuit diagram of the inverter apparatus of FIG. 2;

FIG. 5 shows another example of the circuit diagram of the inverter apparatus of FIG. 2;

FIG. 6 is a configuration diagram showing an example of an inverter apparatus according to another exemplary embodiment of the present disclosure;

FIG. 7 shows an example of a circuit diagram of the inverter apparatus of FIG. 6; and

FIG. 8 shows another example of the circuit diagram of the inverter apparatus of FIG. 6.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

Throughout the drawings, the same or like reference numerals will be used to designate the same or like elements.

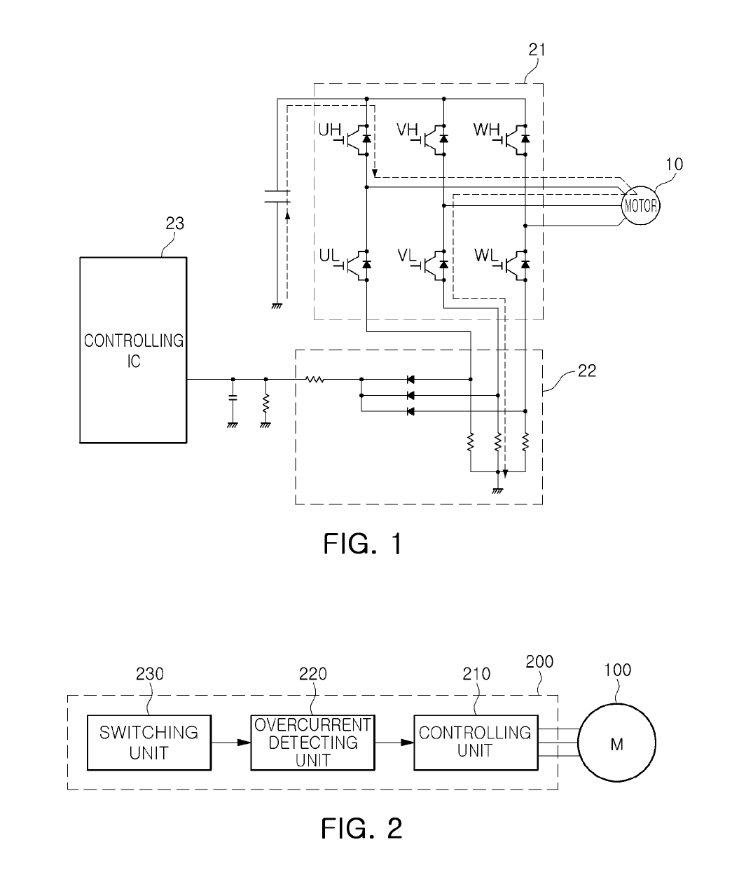

FIG. 1 is a circuit diagram showing an example of a general inverter apparatus.

The inverter apparatus in the shown example may include a sensing resistor 22 in low side switches of a switching unit 21 connected to a motor apparatus 10. Therefore, when an overcurrent flows, the overcurrent may pass through high side switches UH, VH, and WH of the switching unit 21 and be subsequently applied to the motor apparatus 10 as in a path illustrated. Thereafter, the overcurrent may pass through low side switches UL, VL, and WL of the switching unit 21 and be subsequently discharged to a ground terminal.

Therefore, in the example illustrated, since the current is only measured by the sensing resistor 22, protection against the overcurrent may not be enough. For example, in a case in which a short circuit occurs in a switching element or a load side, since a current does not flow in the sensing resistor 22, an overcurrent may not be detected. Thereby, since an overcurrent protection operation is not performed, damage to an internal element or loss in a load terminal may be caused.

FIG. 2 is a configuration diagram showing an example of an inverter apparatus according to an exemplary embodiment of the present disclosure.

Referring to FIG. 2, an inverter apparatus 200 may perform a predetermined switching operation and may provide a driving current to at least a portion of a plurality of phases of the motor apparatus 100.

The inverter apparatus 200 may include a switching unit 210, an overcurrent detecting unit 220, and a controlling unit 230.

The switching unit 210 may include a plurality of switches connected to the plurality of phases of the motor apparatus 100 and perform a switching operation to provide a driving current to at least a portion of phases among the plurality of phases.

In an example, the switching unit 210 may include a plurality of high side switches connected to positive terminals of a plurality of phases and a plurality of low side switches connected to negative terminals of a plurality of phases.

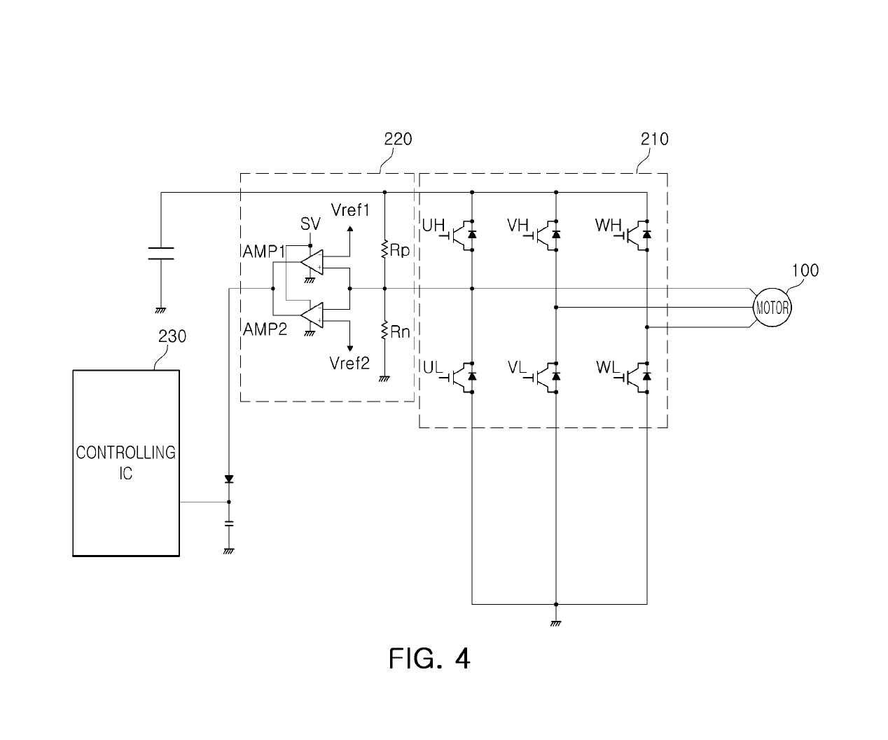

For example, the switching unit 210 of a three-phase motor having U phase, W phase, and V phase may include three high side switches UH, VH, and WH connected to positive terminals of the U phase, the W phase, and the V phase and three low side switches UL, VL, and WL connected to negative terminals of the U phase, the W phase, and the V phase, as shown in FIG. 4.

The overcurrent detecting unit 220 may be connected to the switching unit 210 and may determine whether or not the driving current flowing in the switching unit 210 is in an overcurrent state.

In an example, the overcurrent detecting unit 220 may be connected to the high side switch of the switching unit 210. For example, the overcurrent detecting unit 220 may be connected to a first terminal and a second terminal of the high side switch. Therefore, since the overcurrent detecting unit 220 may be connected to a high side to detect the overcurrent, the occurrence of the overcurrent may be detected even in a case in which the switching element is circuit-shorted.

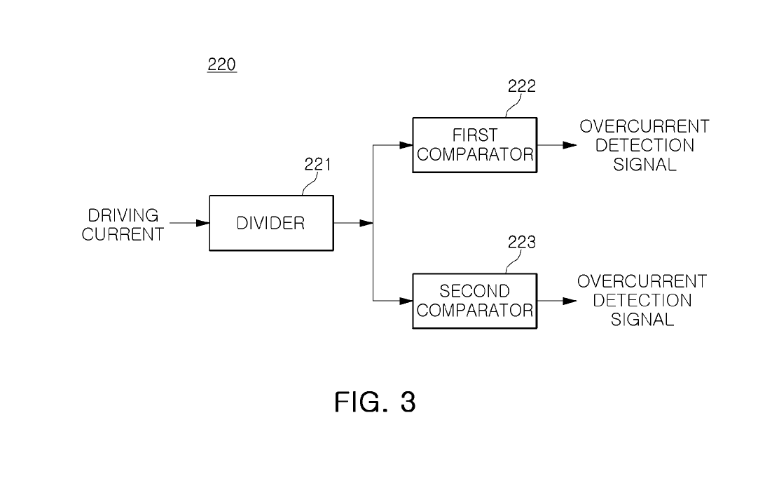

FIG. 3 is a configuration diagram illustrating an example of an overcurrent detecting unit of FIG. 2. Referring to FIG. 3, the overcurrent detecting unit 220 may include a divider 221, a first comparator 222, and a second comparator 223.

The divider 221 may divide the driving current at a preset ratio. In the example of FIG. 4, the divider 221 may include a resistor Rp and a resistor Rn. The divider 221 may reduce a magnitude of an upper limit voltage value of the comparator by dividing the driving current at a predetermined ratio.

The first comparator 222 may compare a voltage of the divided current output from the divider 221 with a preset upper limit voltage value and may output an overcurrent detection signal when a voltage level of the driving current is larger than that of the upper limit voltage value.

The second comparator 223 may compare the voltage level of the divided current with a preset lower limit voltage value and may output the overcurrent detection signal when the voltage level of the driving current is lower than the lower limit voltage value. The upper limit voltage value and the lower limit voltage value may be voltage values.

The first comparator 222 may compare the voltage of the driving current with the preset upper limit voltage value to detect whether or not the driving current itself is in the overcurrent state. In addition, in a case in which the voltage of the driving current drops to be lower than the preset lower limit voltage, the case means that a short circuit occurs at the switching element or the load side of the switching unit 210. Even in this case, the second comparator 223 may output the overcurrent detection signal.

The example of the overcurrent detecting unit 220 shown in FIG. 3 includes the divider 221, but the overcurrent detecting unit 220 may be configured, without the divider 221, depending on examples. That is, in another example, the overcurrent detecting unit 220 may include a first comparator comparing the driving current with the preset upper limit voltage value and a second comparator comparing the driving current with the preset lower limit voltage value.

Referring to FIG. 2, again, the controlling unit 230 may turn at least a portion of the plurality of switches off in response to an output of the overcurrent detecting unit 220.

In an example, when the output of the overcurrent detecting unit 220 is the overcurrent detection signal, the controlling unit 230 may turn at least a portion of the plurality of low side switches off. Therefore, in a case in which the low side switch is turned off, since a short circuit current no longer flows, damage to the switching element may be prevented.

In the example shown in FIG. 3, the output of at least one of the first comparator 222 or the second comparator 223 is in a high state, the controlling unit 230 may turn at least a portion of the plurality of switches off.

FIG. 4 shows an example of a circuit diagram of the inverter apparatus of FIG. 2.

The circuit diagram shown in FIG. 4 may include the overcurrent detecting unit 220 detecting an overcurrent by using a first comparator AMP1 and a second comparator AMP2.

Since the overcurrent detecting unit 220 shown may perform an overcurrent protection operation both at the time of the occurrence of an arm short circuit in which short circuits occur between UH and VH, between VH and VL, and between WH and WL, respectively as well as at the time of the occurrence of a leg short circuit in which short circuits occur between different phases, damage to the switching unit 210 of the inverter apparatus may be prevented.

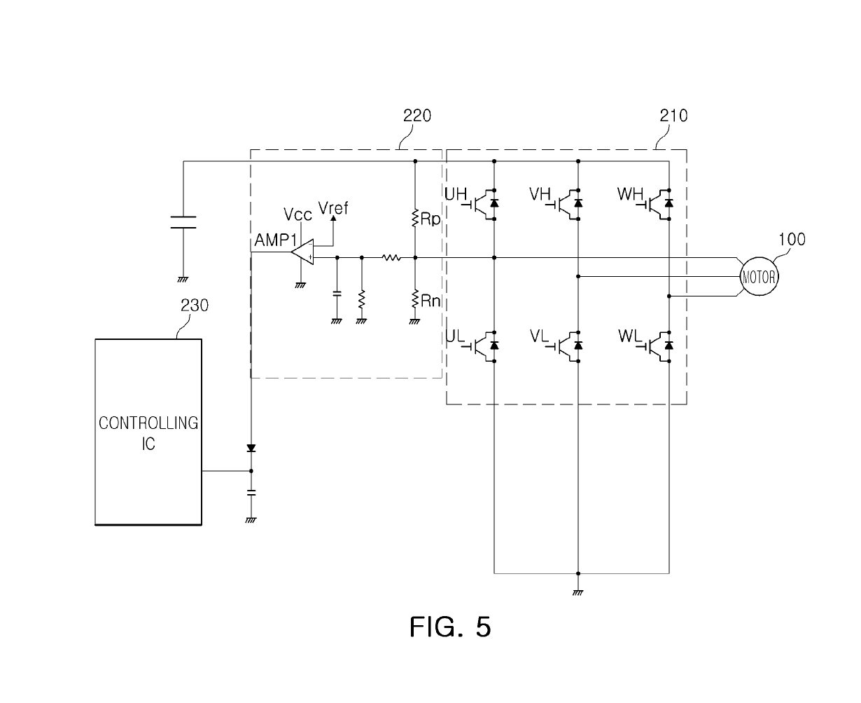

FIG. 5 illustrates another example of the circuit diagram of the inverter apparatus of FIG. 2.

The circuit diagram shown in FIG. 5 may include the overcurrent detecting unit 220 detecting an overcurrent by using a single comparator AMP1.

The overcurrent detecting unit 220 illustrated is an example to which a protection function for a switching element at the high side is added. In the case of the inverter apparatus in which the switching element is used, an overcurrent protection operation for a switching element (e.g., MOSFET or IGBT) at a low side may be generally performed by a low side gate driver IC (LVIC). Therefore, the occurrence of the arm short circuit or the leg short circuit in the switching element at the high side may be detected by using one first comparator capable of protecting the switching element at the high side.

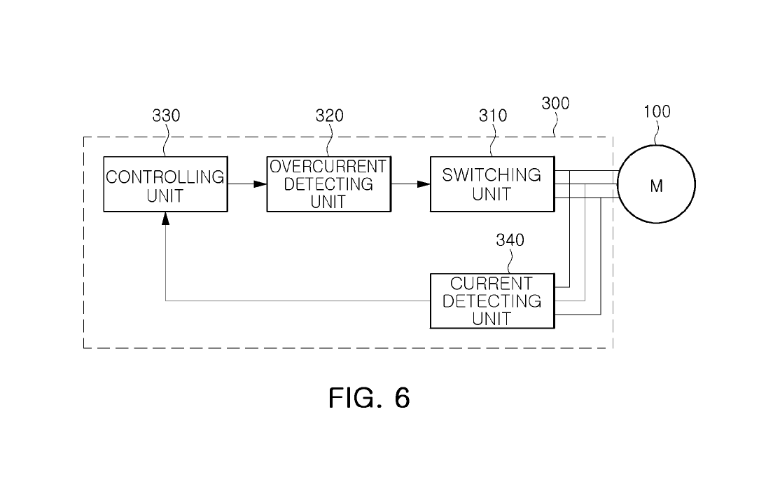

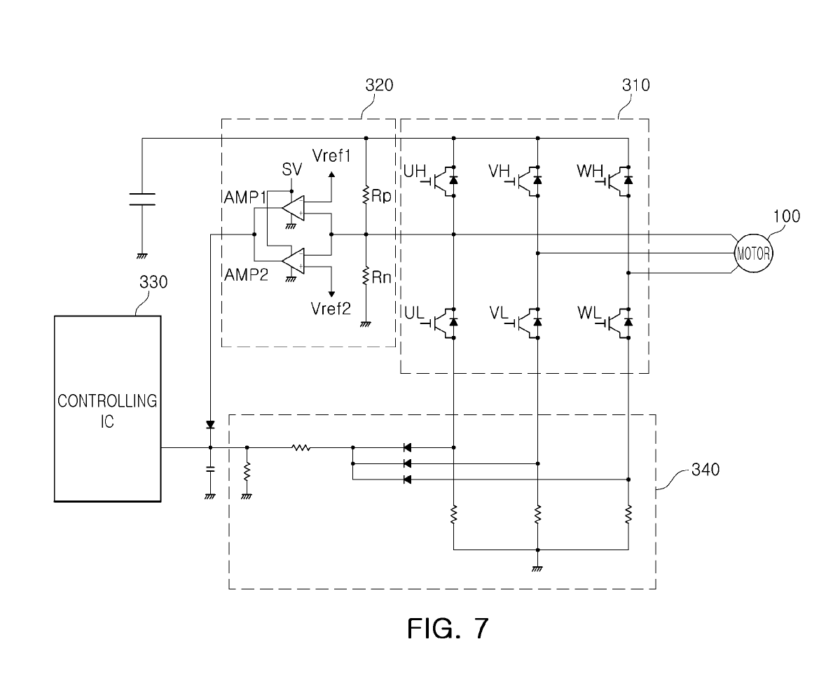

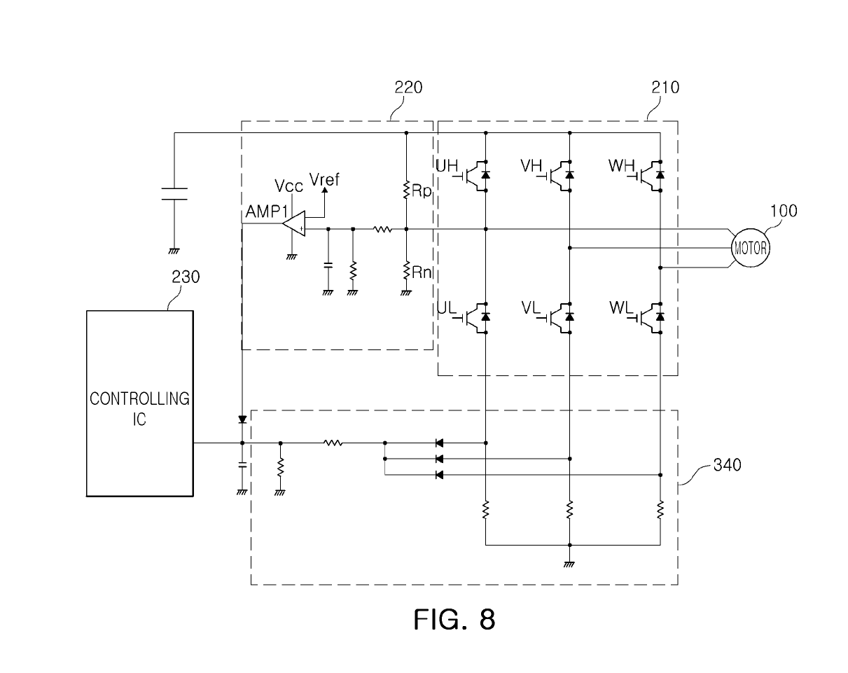

FIG. 6 is a configuration diagram showing an example of an inverter apparatus according to another exemplary embodiment of the present disclosure. FIG. 7 is a circuit diagram for describing an example of the inverter apparatus of FIG. 6.

An inverter apparatus 300 shown in FIGS. 6 and 7 may further include a current detecting unit 340, in addition to the components of the inverter apparatus 200 shown in FIGS. 2 through 5. Overlapped descriptions of contents thereof the same as or corresponding to the contents described above with reference to FIGS. 2 through 5 will be omitted below.

Referring to FIGS. 6 and 7, the inverter apparatus 300 may include a switching unit 310, an overcurrent detecting unit 320, a controlling unit 330, and the current detecting unit 340.

The switching unit 310 may include a plurality of switches connected to a plurality of phases of the motor apparatus 100. The plurality of switches may perform a switching operation to provide a driving current to at least a portion of phases among the plurality of phases.

The overcurrent detecting unit 320 may be connected to an input terminal of the switching unit 310 and may determine whether or not the driving current flowing in the switching unit 310 is in the overcurrent state.

The current detecting unit 340 may be connected to an output terminal of the switching unit 310 and may detect the driving current flowing in the switching unit 310.

The controlling unit 330 may turn at least a portion of the plurality of switches off using outputs of the current detecting unit 340 and the overcurrent detecting unit 320.

That is, in the example, the overcurrent detecting unit 320 may be connected to the input terminal of the switching unit 310 and the current detecting unit 340 may be connected to the output terminal of the switching unit 310. Therefore, the double checking of overcurrent detection may be enabled.

In an example, the switching unit 310 may include the plurality of high side switches UH, VH, and WH connected to positive terminals of a plurality of phases and the plurality of low side switches UL, VL, and WL connected to negative terminals of the plurality of phases.

In an example, when the driving current is in the overcurrent state, the controlling unit 330 may turn at least a portion of the plurality of low side switches off.

In an example, the overcurrent detecting unit 320 may be connected to the plurality of high side switches and the current detecting unit 340 may be connected to the plurality of low side switches.

In an example, the overcurrent detecting unit 320 may include a divider dividing the driving current at a preset ratio, a first comparator comparing a voltage of the divided current output from the divider with a preset upper limit voltage value and a second comparator comparing the voltage of the divided current with a preset lower limit voltage value.

In an example, the first comparator may detect whether or not the driving current is in the overcurrent state.

In an example, the second comparator may detect a short circuit occurring in at least one of the plurality of switches.

In an example, when an output of at least one of the first comparator or the second comparator is in a high state, the controlling unit 330 may turn at least a portion of the plurality of switches off.

As set forth above, according to exemplary embodiments of the present disclosure, damage to a switching element of an inverter may be protected even in a case in which an overcurrent is detected and a protection operation against the overcurrent is performed, by including an overcurrent detecting unit in an input terminal of the switching element of the inverter.

While exemplary embodiments have been shown and described above, it will be apparent to those skilled in the art that modifications and variations could be made without departing from the spirit and scope of the present disclosure as defined by the appended claims.

What is claimed is:

1. An inverter apparatus, comprising:
a switching unit including a plurality of switches connected to a plurality of phases of a motor apparatus and performing a switching operation to provide a driving current to at least a portion of phases among the plurality of phases;
an overcurrent detecting unit connected to the switching unit and determining whether or not the driving current flowing in the switching unit is in an overcurrent state; and
a controlling unit turning at least a portion of the plurality of switches off in response to an output of the overcurrent detecting unit.

2. The inverter apparatus of claim 1, wherein the switching unit includes:
a plurality of high side switches connected to positive terminals of the plurality of phases; and
a plurality of low side switches connected to negative terminals of the plurality of phases.

3. The inverter apparatus of claim 2, wherein the controlling unit turns at least a portion of the plurality of low side switches off when the output of the overcurrent detecting unit is an overcurrent detection signal.

4. The inverter apparatus of claim 1, wherein the overcurrent detecting unit is connected to a first terminal and a second terminal of a high side switch included in the switching unit.

5. The inverter apparatus of claim 1, wherein the overcurrent detecting unit includes:
a divider dividing the driving current at a preset ratio;
a first comparator comparing a voltage of the divided current output from the divider with a preset upper limit voltage value; and
a second comparator comparing the voltage of the divided current with a preset lower limit voltage value.

6. The inverter apparatus of claim 5, wherein the first comparator detects whether or not the driving current is in the overcurrent state.

7. The inverter apparatus of claim 5, wherein the second comparator detects a short circuit occurring in at least one of the plurality of switches.

8. The inverter apparatus of claim 5, wherein the controlling unit turns the at least a portion of the plurality of switches off when an output of at least one of the first comparator or the second comparator is in a high state.

9. The inverter apparatus of claim 1, wherein the overcurrent detecting unit includes:
a first comparator comparing the driving current with a preset upper limit voltage value; and
a second comparator comparing the driving current with a preset lower limit voltage value.

10. An inverter apparatus, comprising:
a switching unit including a plurality of switches connected to a plurality of phases of a motor apparatus and performing a switching operation to provide a driving current to at least a portion of phases among the plurality of phases;
an overcurrent detecting unit connected to an input terminal of the switching unit and determining whether or not the driving current flowing in the switching unit is in an overcurrent state;
a current detecting unit connected to an output terminal of the switching unit and detecting the driving current flowing in the switching unit; and
a controlling unit turning at least a portion of the plurality of switches off using outputs of the current detecting unit and the overcurrent detecting unit.

11. The inverter apparatus of claim 10, wherein the switching unit includes:
a plurality of high side switches connected to positive terminals of the plurality of phases; and
a plurality of low side switches connected to negative terminals of the plurality of phases.

12. The inverter apparatus of claim 11, wherein the controlling unit turns at least a portion of the plurality of low side switches off when the driving current is in the overcurrent state.

13. The inverter apparatus of claim 11, wherein the overcurrent detecting unit is connected to the plurality of high side switches and the current detecting unit is connected to the plurality of low side switches.

14. The inverter apparatus of claim 10, wherein the overcurrent detecting unit includes:
a divider dividing the driving current at a preset ratio;
a first comparator comparing a voltage of the divided current output from the divider with a preset upper limit voltage value; and
a second comparator comparing the voltage of the divided current with a preset lower limit voltage value.

15. The inverter apparatus of claim 14, wherein the first comparator detects whether or not the driving current is in the overcurrent state.

16. The inverter apparatus of claim 14, wherein the second comparator detects a short circuit occurring in at least one of the plurality of switches.

17. The inverter apparatus of claim 14, wherein the controlling unit turns the at least a portion of the plurality of switches off when an output of at least one of the first comparator or the second comparator is in a high state.

18. The inverter apparatus of claim 10, wherein the overcurrent detecting unit includes a first comparator comparing the driving current with the preset upper limit voltage value, and
the first comparator detects a short circuit in a high side switching element of the switching unit.
